(19) United States
(12) Patent Application Publication
(10) Pub. No.: US 2019/0138874 A1
(43) Pub. Date: May 9, 2019

(54) RFID-BASED INDICATOR FOR USE WITH FASTENING SUBSTRATES AND RELATED METHODS

(71) Applicant: SGNT LLC, Tucson, AZ (US)

(72) Inventors: EMIL COLBERT TREMBLAY, TUCSON, AZ (US); JOHN THOMAS ROMPEL, JR., TUCSON, AZ (US)

(21) Appl. No.: 16/184,736

(22) Filed: Nov. 8, 2018

Related U.S. Application Data
(60) Provisional application No. 62/583,828, filed on Nov. 9, 2017.

(51) Int. Cl. G06K 19/077; G06K 19/073; G06K 7/10; G06K 19/07

(52) U.S. Cl. CPC G06K 19/07749; G06K 19/0723; G06K 7/10445; G06K 19/07381

(57) ABSTRACT

An RFID apparatus for securing an object includes a security indication means having a breakable portion and an RFID transponder connected to the security indication means. The RFID transponder has at least one antenna, a collection of transistors, at least one conductive loop, and at least one RFID chip in electrical communication with a write-once circuit. At least a portion of the at least one conductive loop is positioned within the breakable portion of the security indication means. Breaking the at least one conductive loop causes the write-once circuit to change a signal state of the at least one RFID chip.

### CROSS REFERENCE TO RELATED APPLICATION

This application claims the benefit of U.S. Provisional Application Ser. No. 62/583,828, “RFID-Based Indicator for use with Fastening Substrates and Related Methods,” filed Nov. 9, 2017, the entire disclosure of which is incorporated herein by reference.

### FIELD OF THE DISCLOSURE

The present disclosure is generally related to RFID security devices and more particularly is related to tamper-evident RFID fastening substrates.

### BACKGROUND OF THE DISCLOSURE

In the packaging, shipping and transportation industry, it is important to both know where a container is during transit and to ensure that the container is delivered in its original condition. Barcodes, scanners, and the Internet have greatly improved logistics and location tracking. However, they require line-of-sight scanning at close range, which is time-consuming and difficult. Likewise, container integrity can be bolstered by the use of sealing with cellophane, plastic, tapes, zip ties, and other objects. However, seals can be broken and repaired to look intact. A receiving party must still be present to visually inspect a seal upon delivery, and a broken or tampered seal may not indicate which party is liable for any damage. Furthermore, seals only work in practice if the sender, the shipper, and the receiver trust that the seal was installed, used, and inspected correctly.

In another vein, it can sometimes be difficult to distinguish between authentic consumer goods and counterfeit or knock-off versions. Visual appearance alone can be deceiving, as counterfeiters can manufacture goods that closely resemble the authentic product. With the proliferation of online shopping, it can be even more difficult to guarantee that a purchased product comes from the maker or authorized reseller of the true and authentic product.

Thus, a heretofore unaddressed need exists in the industry to address the aforementioned deficiencies and inadequacies.

### SUMMARY OF THE DISCLOSURE

Embodiments of the present disclosure provide an RFID apparatus for securing an object. Briefly described, in architecture, one embodiment of the apparatus, among others, can be implemented as follows. An RFID apparatus for securing an object includes a security indication means having a breakable portion and an RFID transponder connected to the security indication means. The RFID transponder has at least one antenna, a collection of transistors, at least one conductive loop, and at least one RFID chip in electrical communication with a write-once circuit. At least a portion of the at least one conductive loop is positioned within the breakable portion of the security indication means. Breaking the at least one conductive loop causes the write-once circuit to change a signal state of the at least one RFID chip.

The present disclosure can also be viewed as providing methods of verifying that a container has remained secured. In this regard, one embodiment of such a method, among others, can be broadly summarized by the following steps: providing a security indication means securingly connected to a container; providing an RFID transponder connected to the security indication means, the RFID transponder having at least one antenna, a collection of transistors, at least one conductive loop, and at least one RFID chip in electrical communication with a write-once circuit, wherein at least a portion of the at least one conductive loop is positioned within a breakable portion of the security indication means, wherein breaking the at least one conductive loop causes the write-once circuit to change a signal state of the at least one RFID chip; interrogating the RFID transponder with an RFID reader; and determining whether the RFID transponder is communicating a changed signal state.

The present disclosure can also be viewed as providing a package. The package includes a container, a security indication means, and an RFID transponder connected to the security indication means. The RFID transponder has at least one antenna, a collection of transistors, at least one conductive loop, and at least one RFID chip in electrical communication with a write-once circuit. At least a portion of the at least one conductive loop is positioned within a breakable portion of the security indication means. Breaking the at least one conductive loop causes the write-once circuit to change a signal state of the at least one RFID chip.

The present disclosure can also be viewed as providing an RFID tamper-indicating apparatus. Briefly described, in architecture, one embodiment of the apparatus, among others, can be implemented as follows. An RFID tamper-indicating apparatus includes a security indication means having a breakable portion and an RFID transponder connected to the security indication means. The RFID transponder has at least one antenna, a collection of transistors, at least one conductive loop, and at least one RFID chip in electrical communication with a fault detection circuit. At least a portion of the at least one conductive loop is positioned within the breakable portion of the security indication means. The fault detection circuit is configured to indicate when any portion of the security indication means has been re-attached after having been broken.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic illustration of an RFID apparatus for securing an object, in accordance with a first exemplary embodiment of the present disclosure.

FIG. 2 is a circuit diagram of the collection of transistors of the RFID apparatus of FIG. 1, in accordance with the first exemplary embodiment of the present disclosure.

FIG. 3 is a box diagram showing the operating platform of the RFID apparatus of FIG. 1, in accordance with the first exemplary embodiment of the present disclosure.

FIG. 4 is a flow chart illustrating a method of verifying that an object has remained secured, in accordance with the first exemplary embodiment of the present disclosure.

FIGS. 5A-5G show exemplary embodiments of the RFID apparatus in use with a container.

FIGS. 6A-6B are schematic illustrations of an RFID apparatus in use with an object, in accordance with the first exemplary embodiment of the present disclosure.

FIG. 7 shows an RFID apparatus embedded in an object, in accordance with the first exemplary embodiment of the present disclosure.

FIGS. 8A-8C show RFID apparatuses in use with a port on electronic equipment, in accordance with the first exemplary embodiment of the present disclosure.

FIGS. 9A-9D show an RFID tamper-indicating apparatus, in accordance with a second exemplary embodiment of the present disclosure.

### DETAILED DESCRIPTION

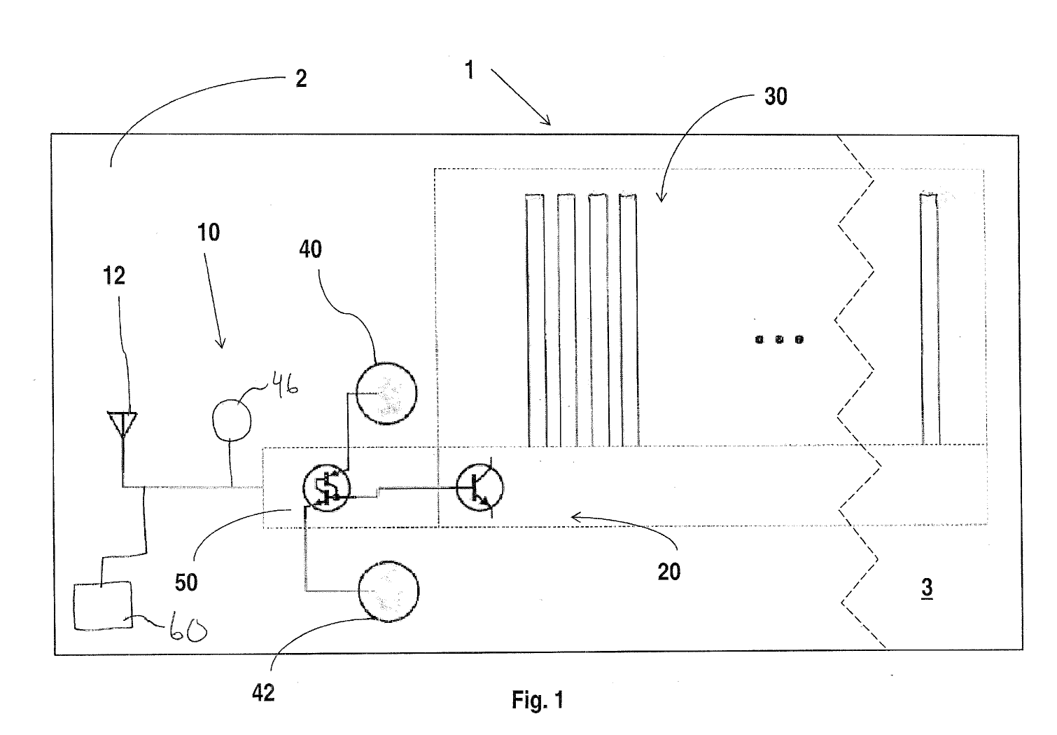

FIG. 1 is a schematic illustration of an RFID apparatus 1 for securing an object, in accordance with a first exemplary embodiment of the present disclosure. The RFID apparatus 1 includes a security indication means 2 and an RFID transponder 10 connected to the security indication means 2. The RFID transponder has at least one antenna 12, a collection of transistors 20, at least one conductive loop 30, and at least one RFID chip 40, 42 in electrical communication with the at least one antenna 12, the collection of transistors 20, and the at least one conductive loop 30. FIG. 1 depicts two RFID chips 40, 42. The RFID chips 40, 42 and the at least one conductive loop 30 are in electrical communication with a write-once circuit 50. At least a portion of the at least one conductive loop is positioned within a breakable portion 3 of the security indication means 2. Breaking the at least one conductive loop 30 causes the write-once circuit 50 to change a state of the at least one RFID chip 40, 42. The changed state signals that the security indication means 2 has been broken.

The security indication means 2 may be any type of material, device, mechanical apparatus, or electrical apparatus used to indicate the security status of an object. In one example, this may include a material, device, mechanical apparatus, or electrical apparatus used to close, seal, lock, mark, or secure a container. The security indication means 2 may serve to close, seal, lock, mark, or secure the container and indicate whether the container is or has remained closed, sealed, locked, marked, or secured. For example, the security indication means 2 may be a tying device, such as a string, rope, zip tie, or wire. As another example, the security indication means 2 may be a tape having an adhesive on one or both sides of a substrate. As another example, the security indication means 2 may be a sticker placed over an opening. The sticker may have text or pictures indicating that the container has been closed. As another example, the security indication means 2 may be a lock, such as a padlock or a cylinder lock. In another example, the security indication means 2 may be a wrapping material, such as cellophane, plastic wrap, shrink wrap, wrapping paper, or a textile. The wrapping material may cover the outer surface of the container in whole or in part. For example, a plastic seal may cover a portion of a medicine bottle, such as the lid and surrounding areas. In yet another example, the security indication means 2 may be an adhesive, such as a glue or epoxy.

In another example, the security indication means 2 may indicate the security status of an object not in a container. For example, the security indication means 2 may be a tag, pin, or security tag, such as may be found on clothing and other products. As another example, the security indication means 2 may be an embedded electrical component implanted in a product to indicate the source or authentic status of the product. As another example, the security indication means 2 may be a tape, sticker, or adhesive substrate placed over a port or opening on electronic equipment such as a computer. As another example, the security indication means 2 may be an electronic plug or dongle that plugs into a port or opening on electronic equipment such as a computer. A computer may be defined as any electronic processing device, including personal computers, servers, smartphones, tablets, wearable mobile devices, televisions, smart appliances, and the like.

An object secured by the security indication means 2 may be a container, apparel, an electronic device, commercial and consumer merchandise, an electronic port, and the like.

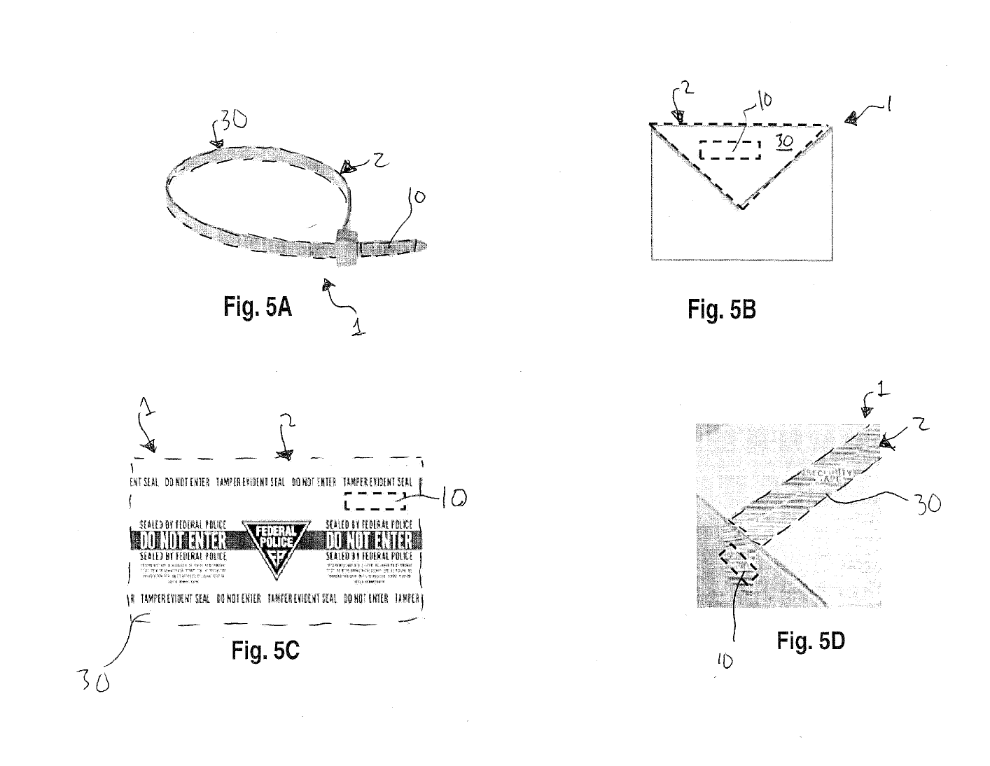

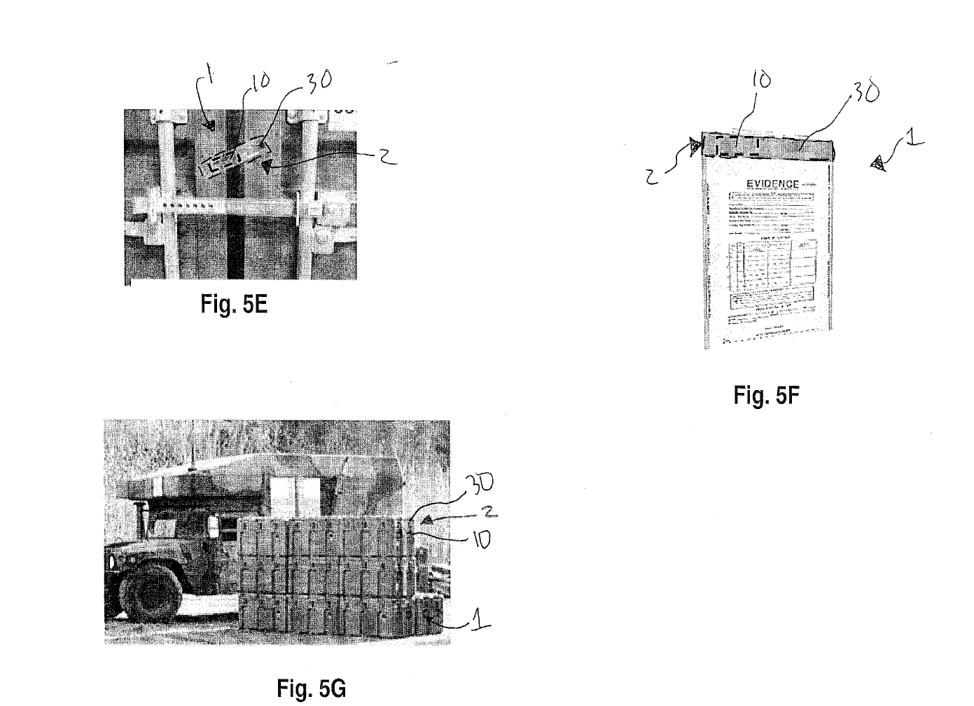

A container (shown in FIGS. 5A-5G) may be any type of structure, material, or device used to hold an object for transport or storage. As an example, the container may be a package commonly used in consumer and commercial shipping, such as a cardboard box, shipping envelope, or tube. As another example, the container may be an envelope, such as a mailing envelope, courier envelope, or evidence container. In another example, the container may be a large shipping container commonly used in commercial freight operations. In yet another example, the container may be a crate, such as those commonly made of wood or plastic. In yet another example, the container may be a bag, a bottle, or a box. The container may be designed for transportation only, i.e., may not be visually appealing to consumers. Alternatively, the container may be retail packaging. In still another example, the container may include an in-situ container such as a room or a building. For instance, the container may be a room located in a crime scene, a quarantined building, or a facility that must remain secure by lock or seal. Exemplary container embodiments with a security indication means 2 are discussed in greater detail in FIGS. 5A-5G.

Apparel may include clothing capable of accepting a tag or security tag. Electronic devices may include personal computers, scientific instruments, portable music players, mobile devices, wearables, appliances, and the like. Commercial and consumer merchandise may include any merchandise for which the source or authentic status must be verified. Examples may include designer or luxury goods, such as handbags, sunglasses, luggage, shoes, art, furniture, and the like. Electronic ports may include ports capable of sending or receiving data, such as USB ports, HDMI ports, Ethernet ports, SATA ports, and other serial data or display ports found on electronic devices.

The security indication means 2 may be tied, fastened, applied, embedded within, or otherwise connected to the object. When the object is a container, the security indication means 2 may be connected to the container when it has been fully engaged to secure the container. When the object is apparel, an electronic device, merchandise, or an electronic port, the security indication means 2 may be tagged, inserted, embedded, fastened, or adhesively applied to the object. The security indication means 2 may be disconnected when a breakable portion 3 is less than fully engaged after having been connected. Depending on the design, in implementation, this may vary in a number of ways. For example, when the security indication means 2 is a tape, sticker, or other adhesive, it may be securingly connected when the entirety of the tape, sticker, or other adhesive has been applied to secure an opening or entry point on the container. The security indication means 2 may be disconnected when the breakable portion 3 of the tape, sticker, or adhesive has been removed, broken, or detached. When the security indication means 2 is a lock or a tie, it may be connected when the lock or tie has been engaged through a portion or opening of the container. The security indication means 2 may be disconnected when the breakable portion 3 of the lock or tie has been undone or cut to any degree. When the security indication means 2 is a seal or wrapping, it may be connected when the entirety of the seal or wrapping has been engaged on the container. It may be disconnected when the breakable portion 3 of the seal or wrapping has been unwrapped or cut to any degree.

When the object is not a container, the security indication means 2 may be connected to any portion of the object. For example, when the security indication means 2 is a tag, it may be connected to apparel, merchandise, furniture, and the like by barbs or other puncture methods. When the security indication means 2 is an embedded electrical component, it may be injected, implanted, or embedded in a discreet portion of an object. When the security indication means 2 is a sticker, tape, or adhesive substrate, it may be placed to cover the opening of an electronic port such that the port cannot be accessed without removing the sticker, tape, or adhesive substrate. When the security indication means 2 is an electronic plug or dongle, it may plug into an electronic port to engage mechanically and electronically with the port.

The breakable portion 3 of the security indication means 2 may be any portion of the security indication means 2. For instance, when the security indication means 2 is a tape, the breakable portion 3 may be substantially all of the tape. When the security indication means 2 is a rope or tie, the breakable portion 3 may be substantially all of the rope or tie. As another example, when the security indication means 2 is a padlock, the breakable portion 3 may only be the shackle or shank of the lock that is placed through the container. When the security indication means 2 is a tag or pin, the breakable portion 3 may be the shank, pin, or connecting elements placed through or into the object. When the security indication means 2 is an embedded electrical component, the breakable portion 3 may be any portion in contact with the object. When the security indication means 2 is an electronic plug or dongle that plugs into a port or opening, the breakable portion 3 may be any electronic portion that creates an electrical connection with the object. When the electrical connection is broken, the security indication means 2 may be considered broken.

The breakable portion 3 may be the portion of the security indication means that is likely to be disconnected. In one example, the RFID chips 40, 42, antenna 12, and write-once circuit 50 may not be located on a breakable portion 3 of the security indication means 2.

The RFID transponder 10 may be disposed on the security indication means 2 in a number of ways. In one example, the RFID transponder 10 may be located directly on a side of the security indication means 2 and secured by an adhesive, a screw, a bolt, or other hardware. In another example, the RFID transponder 10 may be disposed on a substrate that is secured to the security indication means 2. In another example, the RFID transponder 10 is formed with the security indication means 2 and is located therein or thereon, such as when the RFID transponder 10 is embedded within a layer of a security indication means.

The RFID transponder 10 may have at least one antenna 12 for receiving a radio signal from an RFID interrogator. The antenna 12 may be sized and shaped to receive and emit one or more radio frequencies. The RFID transponder 10 may have multiple antennas 12 for receiving and broadcasting multiple radio frequencies or to increase reception and transmission. The antenna 12 may utilize any RFID frequencies available, including low-frequency (LF), high-frequency (HF), and ultra-high-frequency (UHF) bands.

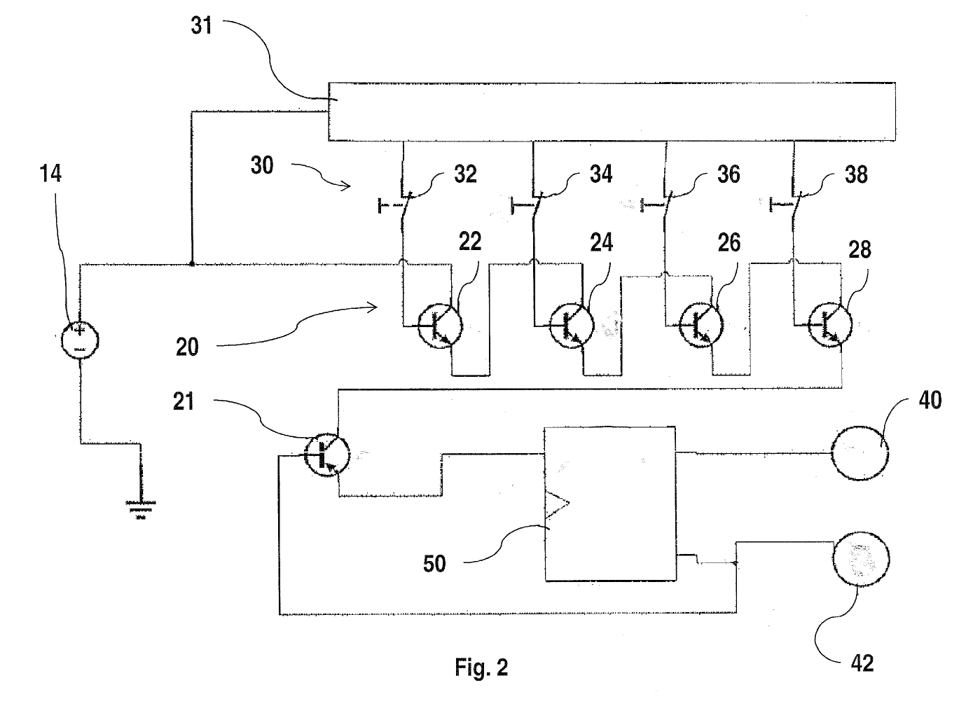

The RFID transponder 10 may also have a collection of transistors 20 in electrical communication with one or more conductive loops 30 and a write-once circuit 50. These are discussed in greater detail in FIG. 2, below.

The RFID transponder 10 may have one or more RFID chips 40, 42 in electrical communication with the antenna 12, the collection of transistors 20, and the conductive loop 30. The RFID chips 40, 42 and the conductive loop 30 may be connected by a write-once circuit 50 capable of changing a signal state of the RFID chips 40, 42. In one example, the RFID transponder 10 may have two RFID chips 40, 42. The first RFID chip 40 may control the base signal state of the RFID transponder 10, which may actively indicate a “secure” status of the object. The second RFID chip 42 may control a changed signal state of the RFID transponder 10, which may actively indicate an “unsecure” status of the object. In another example, a single RFID chip may be able to switch from the base signal state to the changed signal state. In another example, multiple RFID chips may be included to actively indicate that different areas of the object are secure or unsecure. For instance, an RFID transponder 10 with four RFID chips may use two RFID chips to indicate the signal state of the top of an object, and two RFID chips to indicate the signal state of the bottom of an object.

The RFID transponder 10 may be designed to be compliant with one or more industry standards, such as ISO, IEC, ASTM, and EPC standards.

The RFID transponder 10 may have additional components. For instance, the RFID transponder 10 may have an integrated or external power supply, such as one or more solar cells, a battery, or a capacitor. A power supply may allow the RFID transponder 10 to be interrogated using lower powered readers that may be less expensive and easier to obtain. As another example, the RFID transponder 10 may have a power amplifier, such as a capacitor. A power amplifier may allow the RFID transponder 10 to temporarily store energy received from a reader, allowing for the use of lower powered readers. As another example, the RFID transponder 10 may also have an additional RFID chip 46 that provides either asymmetric or symmetric key encryption of the signal state before it is communicated. The encryption RFID chip 46 may encrypt the signal state by applying an encryption modulation to a signal generated by an RFID interrogator. The signal may indicate the signal state of the RFID transponder 10. Encryption of the communicated signal state may provide protection from counterfeiting and spoofing, as false transponder devices will not apply the correct encryption modulation due to the absence of the correct authentication keys for authentication. Encryption may also provide increased privacy, as the ability to read the RFID signal will be limited to readers with the correct keys.

The RFID transponder 10 may also work with additional sensors 60 on the security indication means 2. The sensors 60 may detect one or more transport conditions of the object. For example, environmental sensors such as heat sensors and moisture sensors may sense environmental conditions around the object. If the temperature goes beyond a threshold, or if the object is exposed to too much moisture, the sensor may communicate this with the RFID transponder 10, which may store the information using a memory circuit. When the RFID transponder 10 is interrogated, it may communicate this information to the reader. As another example, handling sensors, such as acceleration and tilt sensors, may sense how the object is being handled. If the object is subject to rapid acceleration or to rolling, the sensor may communicate this with the RFID transponder 10, which may store the information using a memory circuit. When the RFID transponder 10 is interrogated, it may communicate this information to the reader. A combination of sensors may be used.

Additionally, the RFID transponder 10 may be capable of operating using one or more near-field communication (NFC) protocols. In one example, the antenna 12 and RFID chip 40, 42 may be configured to operate using NFC. In another example, the RFID transponder 10 may have a separate antenna 12, RFID chip, and related circuitry to allow for dual use of UHF and NFC communication. The use of NFC may allow additional devices, such as consumer smartphones and tablets, to read the RFID transponder 10.

FIG. 2 is a circuit diagram of the collection of transistors 20 of the RFID apparatus 1 of FIG. 1, in accordance with the first exemplary embodiment of the present disclosure. The collection of transistors 20 may be comprised of one or more transistors 22, 24, 26, 28 with terminals connected in serial to each other. A power source 14 may also be connected to a terminal of the first transistor 22. One or more conductive loops 30 may be connected to the collection of transistors 20. The conductive loops 30 may have a main bus 31 and one or more break points 32, 34, 36, and 38 connected to another terminal on each transistor 22, 24, 26, 28.

The collection of transistors 20 may be any suitable number and arrangement of transistors. In one example, the collection of transistors 20 may be an array or matrix. The transistors 22, 24, 26, 28 may be connected in serial, in parallel, or in any combination thereof. The number and arrangement of the collection of transistors 20 may be dependent on the size and design of the security indication means 2, which may govern the number and arrangement of conductive loops 30 within the security indication means 2.

The collection of transistors 20 may next be connected to a set transistor 21, which is in turn connected to the write-once circuit 50. The write-once circuit 50 may be a latch or memory circuit that can only indicate a single security state change of the object. Once the security state change has been indicated, the write-once circuit 50 may not be changed back to indicate the original security state. The write-once circuit 50 may be a flip-flop, for example a D flip-flop. The write-once circuit 50 may be connected to the one or more RFID chips 40, 42. The conductive loops 30 may be located on, along, or within the security indication means (not shown). The conductive loops 30 may create a circuit within the RFID transponder 10 that, when intact, engages the RFID chip 40, 42 or portion of the RFID chip 40, 42 that signals the base “secure” state. If the security indication means, including any one or more of the conducting loops 30 has been broken, disconnected, or detached, the latch may engage the RFID chip 40, 42 or portion of the RFID chip 40, 42 that signals the changed “unsecure” state. Any attempts to tamper with the RFID transponder 10 may cause the same reaction. The RFID chip 40, 42 may permanently remain in the changed state once it has been flipped, due to the physical breakage of the conducting loops 30 and the nature of the write-once circuit 50. In one example, the write-once circuit 50 may include flash memory. In this example, the flash memory may have a 1-bit capacity to indicate either the “secure” or “unsecure” state. In one example, the write-once circuit 50 may include a fuse or fuse-like apparatus with a breaking element that interrupts the circuit upon receiving an electrical charge. For instance, when the security indication means 2 is broken, an electrical current may flow to the write-once circuit 50, causing the fuse to break and indicate a changed state. The write-once circuit 50 may also include one or more circuit breaker elements to be used in the same way.

Relative to FIGS. 1 and 2, depending on the design, in implementation, breakage of the conductive loops 30 may be dependent on the type and nature of security indication means 2 used. For example, security indication means 2 designed for use with industrial or shipping containers may withstand a significant amount of force before the conductive loops 30 are broken. This may prevent breakage during normal shipping and handling. As another example, security indication means 2 designed for use with consumer goods may withstand much less force before the conductive loops 30 are broken. This may ensure that the RFID apparatus 1 is sensitive enough to change signal states when mishandled during normal shipping and handling.

### OPERATING EXAMPLES

Relative to FIGS. 1 and 2, the following are operating examples of the RFID apparatus 1 being installed, remaining in a “secure” state during use, and changing to an “unsecure” state during use.

In one example, the RFID apparatus 1 may be installed on a container. Before installation, an object may be placed inside the container. For instance, a retailer may place a product inside a shipping box for transportation to a customer. The shipping box may be sealed using a tape embodiment of the RFID apparatus 1, with the RFID transponder 10 embedded in the tape substrate. A reader may be used to interrogate the RFID transponder 10, which causes the antenna 12 to be energized. If all of the conductive loops 30 are intact, the write-once circuit 50 may cause the RFID transponder 10 to maintain its base “secure” signal state. If one or more of the conductive loops 30 has been broken, the write-once circuit 50 may cause the RFID transponder 10 to indicate its changed, or “unsecure” signal state. The energized antenna 12 may communicate the signal state back to the reader, which may record or otherwise report any information to a person or a database. The reader may report that the product is inside the shipping box, the shipping box has been secured by the tape, the tape is intact and connected, and the product is therefore designated “secure.” The reader may also report when, where, and by whom the reading was taken. At this point, the shipping box may be ready for transport.

The shipping box may travel through the supply chain, being scanned and read each step of the way. For example, the shipping box with the product inside may originate in a retail distribution center. The box may be scanned as it is loaded onto a truck en route to a sorting facility, then scanned when it has arrived at the sorting facility. After the box has been sorted, it may be scanned again as it is loaded onto a truck for delivery to the customer. Once the box has arrived at the customer's delivery location, it may be scanned one final time. Each time the box is scanned, the antenna 12 communicates the signal state of the RFID transponder 10. If the tape remains intact, the RFID transponder 10 will signal that the shipping box, and consequently the product, is secure. At each scan point, the reader may upload the signal state, along with the time, date, location, and other relevant data, to a database that may be viewed by the sender, the shipper, or the receiver.

If the shipping box arrives with the RFID transponder 10 reading “secure”, the receiver may be certain that the shipping box was not opened or damaged during transport. Therefore, if the RFID transponder 10 reads “secure”, but the product inside the shipping box is damaged, missing, or modified, the sender may be held liable as the only responsible party. This may also help the sender adjust its fulfillment processes to resolve errors of this type.

If, at any point along the chain, the signal state of the RFID transponder 10 in the tape changes to signal “unsecure,” it will be communicated to the reader at the next scan point. For example, if the signal state of the tape changes to “unsecure” at any time during transport of the product, it may be communicated to the reader the next time it is loaded or unloaded from the truck. The reader may communicate this to the sender, the shipper, and the receiver, so each party has knowledge of the event. Should the product arrive damaged, modified, or missing, the shipper may be held liable as the only responsible party. This may also help the shipper locate problem areas in its transportation chain and adjust its shipping processes to resolve issues of this type.

The signal states are actively communicated by the RFID transponder 10. When the RFID transponder 10 is interrogated by a reader, it energizes the antenna 12, which feeds the RFID transponder 10 to emit a return signal based on the state of the device. When the conductive loops 30 are intact, the RFID transponder 10 actively emits a “secure” signal to the reader. Conversely, when one or more of the conductive loops 30 have been broken, the RFID transponder 10 actively emits an “unsecure” signal to the reader. Unlike RFID devices currently used, this may help the sender, shipper, or receiver to differentiate between an RFID transponder 10 signaling an “unsecure” state and one that is malfunctioning, i.e., not emitting a signal. Actively emitting “secure” or “unsecure” signals may provide timely and accurate information to all interested parties.

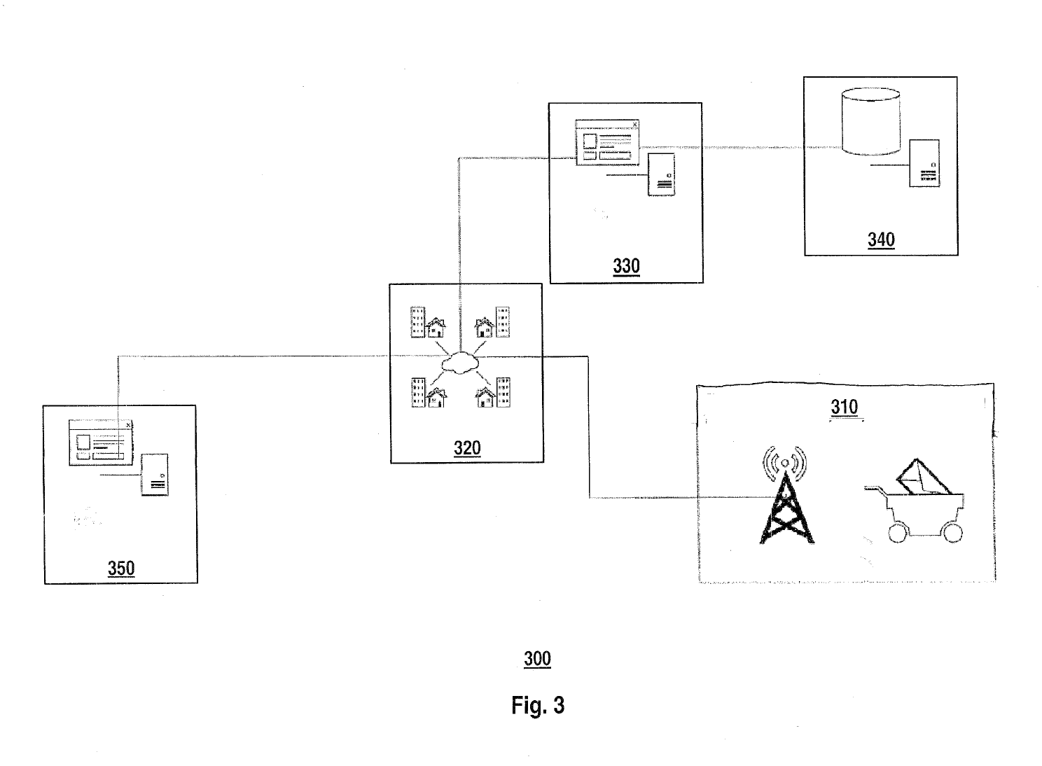

FIG. 3 is a box diagram 300 showing the operating platform of the RFID apparatus of FIG. 1, in accordance with the first exemplary embodiment of the present disclosure. As shown in box 310, an object is placed in a container and secured, becoming a secured object. As the secured object travels along a transit route, it may be interrogated by an RFID reader. The RFID reader may obtain the signal state information of the secured object, i.e., whether it is communicating a “secured” signal state or an “unsecured” signal state.

As shown in box 320, the RFID reader may be connected to a network, such as a local area network or a wide area network. In one example, the RFID reader is connected to the internet via wired, wireless, or cellular networks.

As shown in boxes 330 and 340, information gathered from the RFID reader may be communicated via a software system 330 and database 340, such as a web interface or software program. The software system 330 may provide an end user with a cryptographically secure database 340 containing all of the RFID apparatuses in use or available for use. The database 340 may allow a user to query the status of one or more apparatuses, and it may keep a temporal record of the status of all RFID apparatuses. In one example, a user may also verify the authenticity of an apparatus to ensure that the apparatus has not been counterfeited, faked, or spoofed. The database 340 and software system 330 may allow a user to run more advanced analytics. For example, a user may be able to analyze patterns of mispacked, incorrect, or damaged shipments to determine the conditions under which they occurred. This may be useful for determining where theft or errors occur most frequently and where the user may take steps to prevent them. This may also be useful for determining which shippers handle deliveries most carefully or most thoroughly. The software system 330 may also allow one or more of a sender, shipper, and receiver to receive notifications when shipment data has changed. For example, a sender may wish to receive notifications as soon as any RFID apparatuses signal an “unsecure” state of the container. As another example, a shipper may want periodic updates on the status of all containers along a certain route, for instance, every hour or every minute. Or, a consumer receiver may wish to be notified every time a container is scanned. Notifications may contain information regarding the signal state of a container, the time, date, and location it was scanned, and the identity of the scanner, among others.

The software system 330 may be a standalone application or it may be integrated with other software systems 330. As shown in block 350, information gathered from the RFID reader may be communicated along a user's infrastructure. For example, distribution centers or retail users may have user-end software systems that monitor inventory shipments. The information gathered from the RFID reader may integrate with the user-end software through the use of an Application Programming Interface (API), Software Development Kit (SDK), or other development platform.

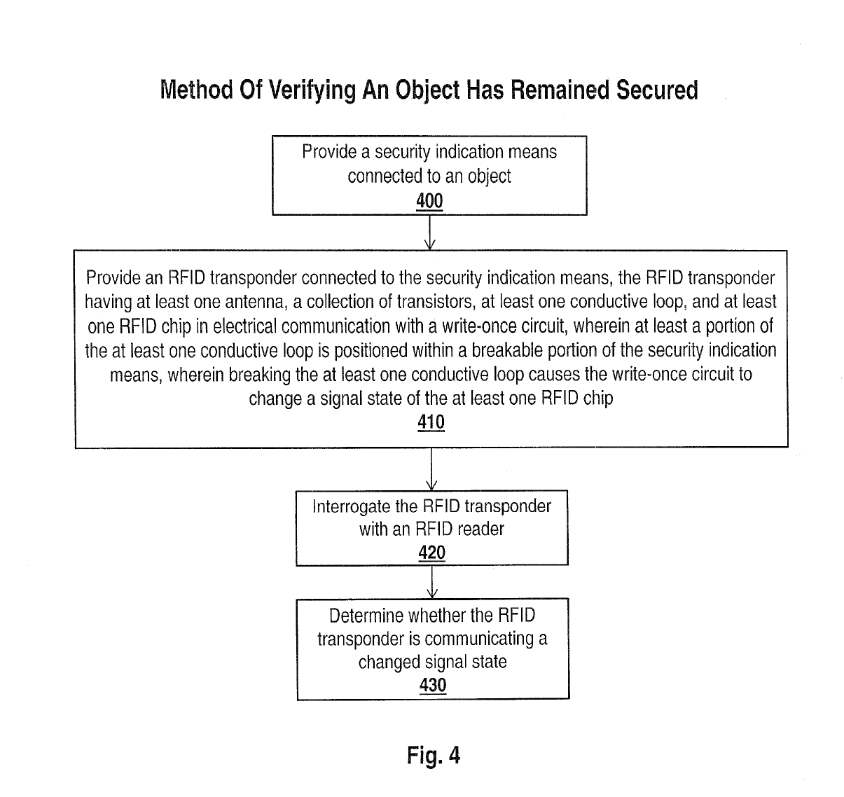

FIG. 4 is a flow chart illustrating a method of verifying that an object has remained secured, in accordance with the first exemplary embodiment of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 400, a security indication means connected to a container is provided.

As is shown in block 410, an RFID transponder connected to the security indication means is provided, the RFID transponder having at least one antenna, at least one RFID chip in electrical communication with the at least one antenna, the collection of transistors, and at least one conductive loop, wherein the at least one RFID chip and the at least one conductive loop are connected by a write-once circuit, wherein breaking the at least one conductive loop causes the write-once circuit to change a state of the at least one RFID chip.

As is shown in block 420, the RFID transponder is interrogated with an RFID reader.

As is shown in block 430, a determination is made whether the RFID transponder is communicating a changed signal state.

FIGS. 5A-5G show exemplary embodiments of the RFID apparatus 1 in use with a container. In each of FIGS. 5A-5G, the RFID apparatus 1 is shown having a security indication means 2. The RFID transponder 10 is connected to the security indication means 2. At least one conductive loop 30 is positioned within a breakable portion of the security indication means 2. Where the security indication means 2, RFID transponder 10, or conductive loop 30 are located underneath a portion of the container or the RFID apparatus 1, they may be indicated with broken lines.

In FIG. 5A, the RFID apparatus is shown as a zip tie which may be fastened around the enclosure of a container.

In FIG. 5B, the RFID apparatus is shown as the adhesive backing on a mailing envelope, which may be applied to seal the opening of the envelope.

In FIG. 5C, the RFID apparatus is shown as a room or building seal, which may be applied to seal the opening of a room, building, or other facility.

In FIG. 5D, the RFID apparatus is shown as tape, which may be applied to seal the lid of a shipping box or other similar containers.

In FIG. 5E, the RFID apparatus is shown as a sticker, which may be applied to ensure that a shipping container has remained secured.

In FIG. 5F, the RFID apparatus is shown as an adhesive strip on an evidence container, which may be applied to ensure that the evidence container has remained sealed and secured.

In FIG. 5G, the RFID apparatus is shown as a clasp, which may be applied to an equipment crate to ensure it has remained secured.

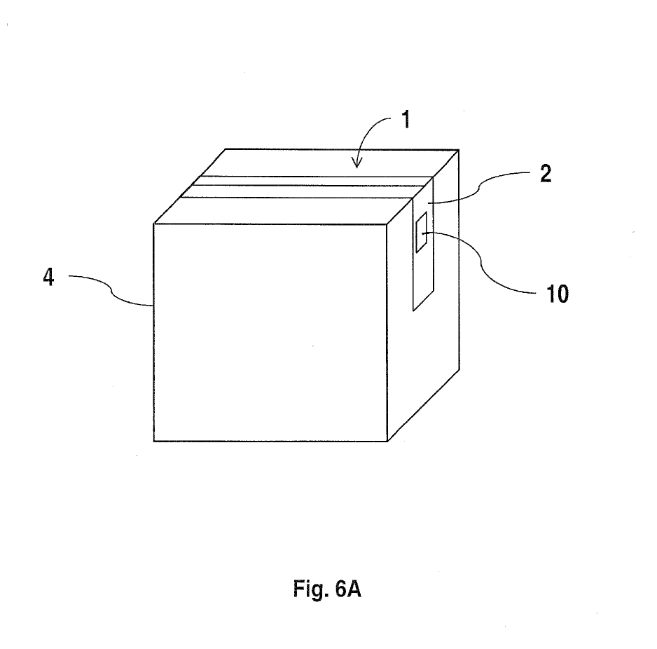

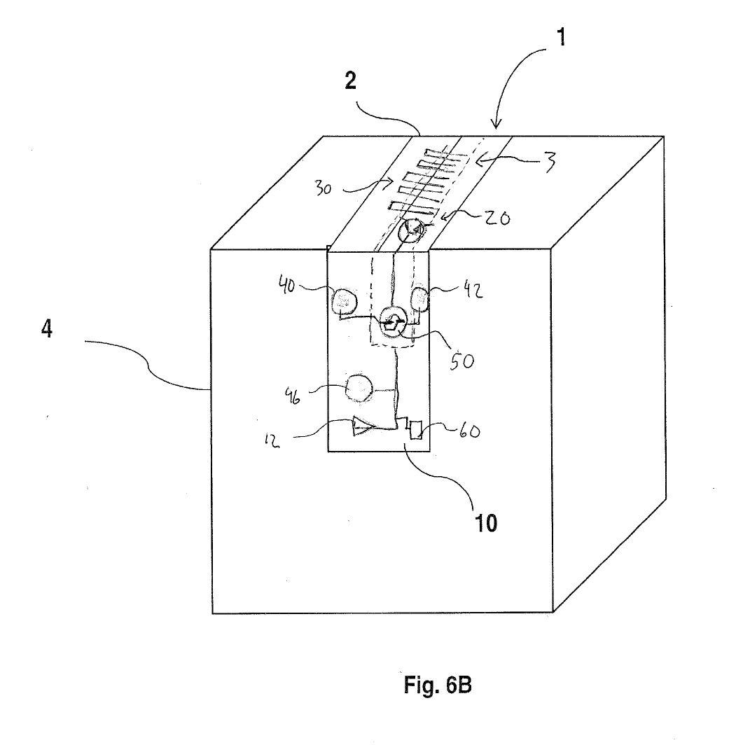

FIGS. 6A-6B are schematic illustrations of an RFID apparatus 1 in use with an object, in accordance with the first exemplary embodiment of the present disclosure. FIG. 6A shows the RFID apparatus 1 with an RFID transponder 10 embedded within the security indication means 2. The security indication means 2 is shown as a tape placed over the flaps of a container 4. The tape secures the flaps of the container 4 during transport. Additionally, if the container 4 is opened by breaking a section of the security indication means 2, the RFID transponder 10 may communicate a changed signal state.

FIG. 6B shows the electronic components of the RFID apparatus 1 as they are integrated with the security indication means 2 on the container 4. A non-breakable portion of the security indication means 2 is placed on a side of the container 4. The electronic components located thereon may include any of the components discussed relative to FIG. 1, above, including the RFID transponder 10, the at least one antenna 12, the collection of transistors 20, the RFID chips 40, 42, additional RFID chip 46, write-once circuit 50, and any additional sensors 60. A breakable portion 3 of the security indication means 2 may be located across the top of the container 4, where the container 4 can be opened. The at least one conductive loop 30 may be integrated within the security indication means 4 at the breakable portion 3. If a person attempts to open the container 4 by breaking the security indication means 3, they may cause the at least one conductive loop 30 to break, resulting in a signal state change of the RFD apparatus 1 to indicate an “unsecure” state.

It should be understood that each of the embodiments of the RFID apparatus 1 discussed relative to FIGS. 1-4, and especially relative to FIGS. 5A-5G may incorporate the electronic components of the RFID apparatus 1 as shown in FIGS. 6A-6B. The manner of incorporation may be dependent upon the form factor of the security indication means 2, the intended object, or the intended use of the security indication means 2 with the object. For instance, security indication means 2 having a tape or substrate form factor may incorporate the electronic components by locating the electronic components between 2 or more layers of the substrate.

This may allow the electronic components to be integrated with the security indication means 2 while remaining protected from external elements. Security indication means 2 having a tie, rope, zip, or lock form factor may incorporate the electronic components by forming the tie, rope, zip, or lock around the electronic components during manufacture. In one example, the conductive loop 30 may be formed or manufactured with the security indication means 2, while the antenna 12, collection of transistors 20, RFID chips 40, 42, write-once circuit 50, and any other electrical components may be formed separately and electronically connected to the conductive loop 30 when the RFID apparatus 1 is ready to be used. For example, when the security indication means 2 is a wrapping material, the conductive loop 30 may be integrated with the entirety of the wrapping material. The additional electronic components may be connected after the object has been wrapped.

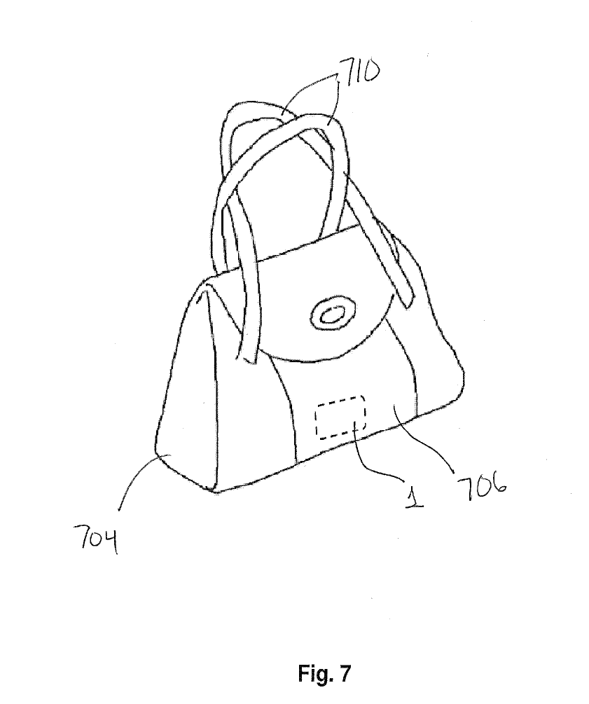

FIG. 7 shows an RFID apparatus 1 embedded in an object 704, in accordance with the first exemplary embodiment of the present disclosure. In this example, the RFID apparatus 1 may be an embedded electrical component. The RFID apparatus 1 may have a small, discreet form factor such that it may be embedded within the object 704 without any visual indication thereof. The object 704 is shown as a handbag; however, the object 704 may be any number of items of merchandise. The RFID apparatus 1 may be embedded in any portion of the object 704, including a sidewall 706 or one of the handles 710. The RFID apparatus 1 may, as its base state, indicate that the object 704 was assembled by an authentic manufacturer of a particular object. For instance, in the handbag example, the RFID apparatus 1 may be embedded by the manufacturer for a particular name brand, such as Prada. In its base state, the RFID apparatus 1 may communicate a particular, or even encrypted code that can be made only by the manufacturer for the brand. When the handbag is received by a retailer or a customer, the handbag may be scanned using an RFID interrogator. The RFID interrogator may read the security state signal from the RFID apparatus 1, and if it matches the particular code for the manufacturer, may indicate that the handbag is genuine and authentic. If the handbag returns no signal or a signal from a different manufacturer, the RFID interrogator may indicate that the handbag is not authentic. Likewise, if the RFID apparatus 1 is removed from the genuine handbag, it may indicate a changed signal state, suggesting that the apparatus 1 has been tampered with or that the object is inauthentic. This may prevent the RFID apparatus 1 from being placed into an inauthentic handbag. This may also prevent counterfeiters from attempting to copy the encrypted code or signal. If the RFID apparatus 1 is embedded within the handles 710 of the handbag, the breakable portion of the RFID apparatus 1 may continue from the handles 710 to the main compartment of the handbag such that if the handles 710 were removed, this would cause the signal state of the RFID apparatus 1 to change from its base state. The embedded electrical component example of the RFID apparatus 1 is not limited to handbags, but may be embedded in any goods capable of receiving the RFID apparatus 1.

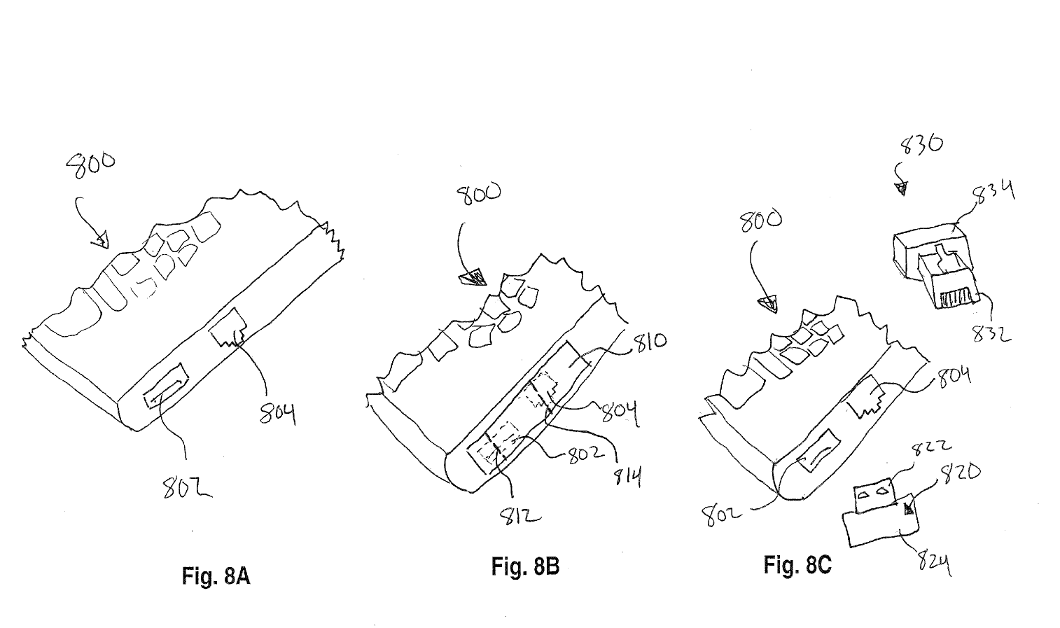

FIGS. 8A-8C show RFID apparatuses 810, 820, 830 in use with a port 802, 804 on electronic equipment, in accordance with the first exemplary embodiment of the present disclosure. FIG. 8A shows, as an example, a computer 800 having a USB port 802 and an Ethernet port 804. Other ports or data connections may be included within the scope of this disclosure, as discussed above.

FIG. 8B shows an RFID sticker 810 placed over the USB and Ethernet ports 802, 804, covering access to the ports. The RFID sticker 810 may have breakable portions 812, 814 which will cause the RFID sticker 810 to separate into multiple parts if it is removed from the computer 800. As discussed relative to FIGS. 1-4 above, the act of breaking the RFID sticker 810 may cause the RFID sticker 810 to indicate a signal state that is changed from its base state. This may indicate to a user that the RFID sticker 810 has been removed and that someone has attempted to gain access to the USB port 802 or Ethernet port 804.

FIG. 8C shows a computer 800 having a USB port 802 and Ethernet port 804. RFID USB dongle 820 and RFID Ethernet dongle 830 are also shown. The RFID USB dongle 820 may include a USB connector 822 to engage with the USB port 802 and a body 824 to help a user insert the RFID USB dongle 820. The RFID Ethernet dongle 830 may include an Ethernet connector 832 (having an RJ-45 end) to engage with the Ethernet port 804 and a body 834 to help a user insert the RFID Ethernet dongle 830. The RFID USB and Ethernet dongles 820, 830 may be inserted into the ports 802, 804 as a cable or other device would, thereby establishing a mechanical connection to the ports 802, 804. Upon connecting, the RFID USB and Ethernet dongles 820, 830 may establish an electrical connection with the USB port 802 and Ethernet port 804. As long as the connection remains intact, the signal state of the devices may indicate a secure port. If the devices are removed, the signal state may change to indicate that the ports are not secure.

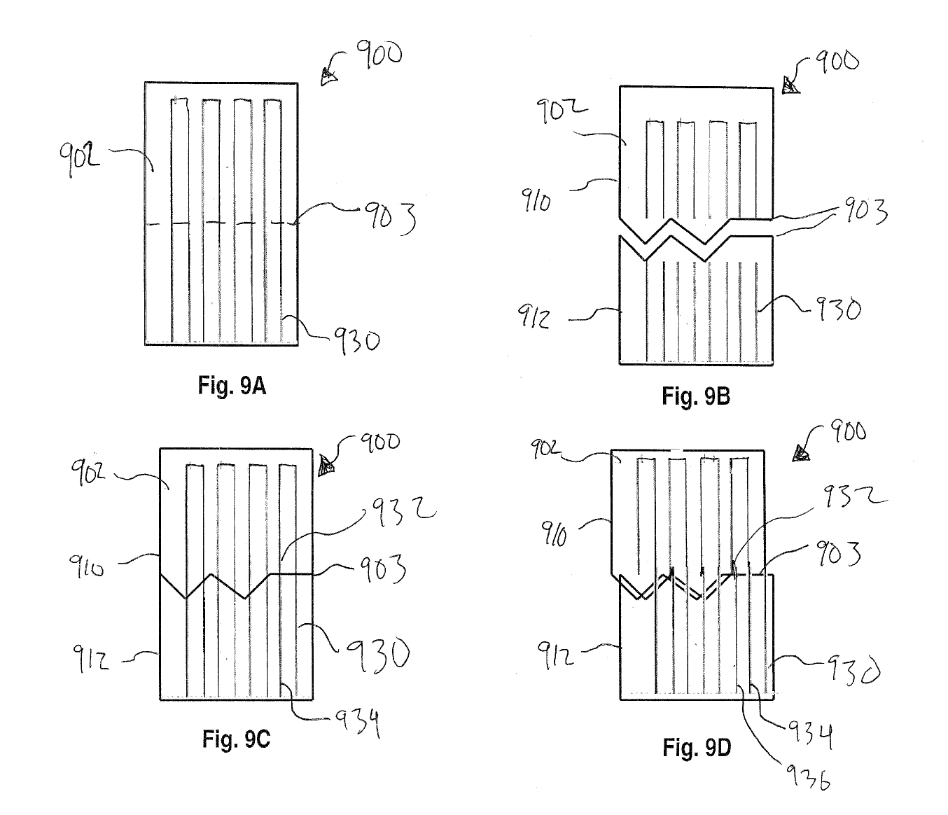

FIGS. 9A-9D show an RFID tamper-indicating apparatus (“tamper indicator”) 900, in accordance with a second exemplary embodiment of the present disclosure. FIG. 9A shows the tamper indicator 900 as an elongated substrate, such as a tape or sticker. However the tamper indicator 900 may take any of the form described above. The tamper indicator 900 includes a security indication means 902 having a breakable portion 903. An RFID transponder is connected to the security indication means 902, the RFID transponder having at least one antenna, a collection of transistors, at least one conductive loop 930, and at least one RFID chip in electrical communication with a fault detection circuit. The RFID transponder may be the same as or substantially similar to the RFID transponder discussed relative to FIGS. 1 and 2 above. Only the at least one conductive loop 930 is shown for simplicity. At least a portion of the at least one conductive loop 930 is positioned within the breakable portion 903 of the security indication means 902. The fault detection circuit is configured to indicate when any portion of the security indication means 902 has been re-attached after having been broken.

FIG. 9B shows the tamper indicator 900 broken along the breakable portion 903 of the security indication means 902. The tamper indicator 900 is divided into a plurality of portions 910, 912 along the breakable portion 903. The at least one conductive loop 930 is broken along the breakable portion 903. This may cause the fault detection circuit to detect that the tamper indicator 900 has been broken, prompting the fault detection circuit to create a signal indicating the change in security state.

FIG. 9C shows the tamper indicator 900 placed back together, where portions 910, 912 have been reattached along the breakable portion 903 of the security indication means 902. The at least one conductive loop 930 has been reattached properly, such that ends 932, 934 that were originally connected have been reconnected together. This reconnection may cause the fault detection circuit to create a signal indicating that the tamper indicator 900 has been placed back together, changing the signal state of the tamper indicator 900 again. However, this second changed signal state may not be the same as the base state indicating that the tamper indicator 900 is secure. This second changed signal state may indicate that the tamper indicator 900 has changed from “unsecure” to “reattached.” This may allow a person reading the signal state at a later point to determine that the tamper indicator 900 was unsecure for a time, but was made to appear secure thereafter. This may indicate that someone attempted to tamper with the object to which the tamper indicator 900 is connected.

FIG. 9D shows the tamper indicator 900 placed back together improperly. The portions 910, 912 have been joined again; however, portion 910 is slightly offset from portion 912. The lack of alignment may cause the at least one conductive loop 930 to be misaligned, such that ends 932, 934 that were originally connected have not been reconnected. Instead, end 932 may be connected to another end 936, and the at least one conductive loop 930 may create a shortened or bypass loop. This may cause the fault detection circuit to create a signal indicating that the tamper indicator 900 has been misaligned. This second changed signal state may again differ from the original base state, instead allowing a person reading the signal state at a later point to determine that the tamper indicator 900 was unsecure for a time, and was placed back together in a misaligned manner. This may indicate that someone attempted to tamper with the object to which the tamper indicator 900 is connected. The tamper indicator 900 may include a 2-bit or greater latch or memory circuit to remember the changes in signal states.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. An RFID apparatus for securing an object, comprising:
a security indication means having a breakable portion; and
an RFID transponder connected to the security indication means, the RFID transponder having at least one antenna, a collection of transistors, at least one conductive loop, and at least one RFID chip in electrical communication with a write-once circuit,
wherein at least a portion of the at least one conductive loop is positioned within the breakable portion of the security indication means, and wherein breaking the at least one conductive loop causes the write-once circuit to change a signal state of the at least one RFID chip.

2. The RFID apparatus of claim 1, wherein the security indication means is selected from the group consisting of a tying device, a tape, a sticker, a lock, a wrapping material, an adhesive substrate, and an embedded electronic device.

3. The RFID apparatus of claim 1, wherein the at least one RFID chip further comprises a first RFID chip to control a base signal state of the RFID transponder and a second RFID chip to control a changed signal state of the RFID transponder.

4. The RFID apparatus of claim 3, wherein the base signal state of the RFID transponder indicates a secure status of the object, and wherein the changed signal state of the RFID transponder indicates an unsecure status of the object.

5. The RFID apparatus of claim 3, wherein the base signal state of the RFID transponder indicates an authentic status of the object, and wherein the changed signal state of the RFID transponder indicates an inauthentic status of the object.

6. The RFID apparatus of claim 1, further comprising an encryption RFID chip, wherein the encryption RFID chip applies an encryption modulation to a communicated signal indicating the signal state of the RFID transponder.

7. The RFID apparatus of claim 1, further comprising a sensor in communication with the RFID transponder, wherein the sensor detects a transport condition of the object.

8. The RFID apparatus of claim 7, wherein the transport condition is selected from the group consisting of: a temperature, a moisture level, and an acceleration.

9. The RFID apparatus of claim 1, wherein the security indication means is a dongle sized to create an electrical connection with a port on electronic equipment.

10. A method of verifying that an object has remained secured, comprising the steps of:
providing a security indication means connected to the object;
providing an RFID transponder connected to the security indication means, the RFID transponder having at least one antenna, a collection of transistors, at least one conductive loop, and at least one RFID chip in electrical communication with a write-once circuit, wherein at least a portion of the at least one conductive loop is positioned within a breakable portion of the security indication means, wherein breaking the at least one conductive loop causes the write-once circuit to change a signal state of the at least one RFID chip;
interrogating the RFID transponder with an RFID reader; and
determining whether the RFID transponder is communicating a changed signal state.

11. The method of claim 10, wherein the object is selected from the group consisting of an envelope, a shipping container, a crate, a bag, a bottle, a box, and a room.

12. The method of claim 10, wherein the security indication means is selected from the group consisting of a tying device, a tape, a sticker, a lock, a wrapping material, and an adhesive substrate.

13. The method of claim 10, wherein the at least one RFID chip further comprises a first RFID chip controlling a base signal state of the RFID transponder and a second RFID chip controlling a changed signal state of the RFID transponder.

14. The method of claim 13, wherein the base signal state of the RFID transponder indicates a secure status of the object, and wherein the changed signal state of the RFID transponder indicates an unsecure status of the object.

15. A package comprising:
a container;
a security indication means connected to the container; and
an RFID transponder connected to the security indication means, the RFID transponder having at least one antenna, a collection of transistors, at least one conductive loop, and at least one RFID chip in electrical communication with a write-once circuit, wherein at least a portion of the at least one conductive loop is positioned within a breakable portion of the security indication means, wherein breaking the at least one conductive loop causes the write-once circuit to change a signal state of the at least one RFID chip.

16. The package of claim 15, wherein the container is selected from the group consisting of an envelope, a shipping container, a crate, a bag, a bottle, a box, and a room.

17. The package of claim 15, wherein the security indication means is selected from the group consisting of a tying device, a tape, a sticker, a lock, a wrapping material, and an adhesive substrate.

18. The package of claim 15, wherein the at least one RFID chip further comprises a first RFID chip to control a base signal state of the RFID transponder and a second RFID chip to control a changed signal state of the RFID transponder.

19. The package of claim 18, wherein the base signal state of the RFID transponder indicates a secure status of the object, and wherein the changed signal state of the RFID transponder indicates an unsecure status of the object.

20. An RFID tamper-indicating apparatus, comprising:
a security indication means having a breakable portion; and
an RFID transponder connected to the security indication means, the RFID transponder having at least one antenna, a collection of transistors, at least one conductive loop, and at least one RFID chip in electrical communication with a fault detection circuit,
wherein at least a portion of the at least one conductive loop is positioned within the breakable portion of the security indication means, and wherein the fault detection circuit is configured to indicate when any portion of the security indication means has been re-attached after having been broken.
